(19) United States
(12) Patent Application Publication
(10) Pub. No.: US 2016/0047331 A1
(43) Pub. Date: Feb. 18, 2016

(54) METHOD OF REMANUFACTURING AN ENGINE BLOCK

(71) Applicant: Caterpillar Inc., Peoria, IL (US)

(72) Inventors: Curtis J. GRAHAM, Peoria, IL (US); Adam W. Ostein, Corinth, MS (US); Luis A. Vazquez, Peoria, IL (US)

(73) Assignee: Caterpillar Inc., Peoria, IL (US)

(21) Appl. No.: 14/462,283

(22) Filed: Aug. 18, 2014

(51) Int. Cl. F02F 1/18; B23P 19/04; F02F 1/00

(52) U.S. Cl. CPC F02F 1/18; F02F 1/004; B23P 19/042

(57) ABSTRACT

A method of remanufacturing an engine block is provided. An insert is removed from a recess in a top deck of the engine block that surrounds a cylinder bore in the engine block. A used cylinder liner is removed from the cylinder bore. The used cylinder liner has a flange on an upper edge thereof having a first thickness. The recess in the top deck of the engine block is cleaned. A replacement cylinder liner is positioned in the cylinder bore. The replacement cylinder liner has a flange on an upper edge thereof that is received in the cleaned recess. The flange of the replacement cylinder liner has a second thickness that corresponds to the sum of the first thickness and the depth of the cleaned recess.

### TECHNICAL FIELD

This patent disclosure relates generally to a method for remanufacturing an engine block and, more particularly, to a method for remanufacturing an engine block by replacing the cylinder liner.

### BACKGROUND

Many components of an internal combustion engine, such as a multi-cylinder diesel or gasoline engine, are subject to high loads and wear during operation of the engine. One such component, for example, is the engine block, which may experience loads from combustion events occurring within combustion chambers formed by the cylinder head, pistons, and cylinder bores of the engine block. These events may subject the engine block to high loads and stresses, including thermal stresses and mechanical stresses, which may be transmitted to the engine block at, among other locations, the cylinder head, which is mounted to a top deck of the engine block, and the cylinder bores. As a result of these stresses, small cracks may form, or general wear may occur, within the engine block, particularly within or near the cylinder bores at the top deck of the engine block.

Each cylinder bore of an internal combustion engine may include a cylinder liner in which the piston actually reciprocates. Cylinder liners allow an engine block with a particular cylinder bore configuration size to be used with multiple different diameter pistons by simply changing the cylinder liners for a particularly configured engine. In the assembled engines, the liners may be held in place by a flange at the upper end of the liner that is held between the block and cylinder head. The cylinder liners may be removed and replaced if worn through use over time. For example, U.S. Pat. No. 8,468,694 discloses a method for remanufacturing a flanged cylinder liner that involves machining a top portion of the cylinder liner to remove the cylinder liner flange and to create a flange seat. A replacement flanged sleeve collar is brought into engagement with the flange seat and affixed onto the collar.

One method for repairing or remanufacturing engine blocks involves removing worn portions of the engine block adjacent a cylinder bore, and installing inserts in the cavities or grooves formed in the engine block to bring the block back into conformity with original specifications. The insert is generally made of stainless steel and is pressed fit into the groove. When the engine block comes back for a second remanufacturing, the insert must be removed and replaced. One problem with such inserts is that they can make it difficult to provide a good seal between the cylinder liner and the cylinder bore.

### SUMMARY

In one aspect, the disclosure describes a method of remanufacturing an engine block. An insert is removed from a recess in a top deck of the engine block that surrounds a cylinder bore in the engine block. A used cylinder liner is removed from the cylinder bore. The used cylinder liner having a flange on an upper edge thereof having a first thickness measured between an upper surface of the flange and a lower surface of the flange. The recess in the top deck of the engine block is cleaned. The cleaned recess having a depth measured from the top deck of the engine block to a bottom surface of the recess. A replacement cylinder liner is positioned in the cylinder bore. The replacement cylinder liner has a flange on an upper edge thereof that is received in the cleaned recess. The flange of the replacement cylinder liner has a second thickness measured between an upper surface of the flange and a lower surface of the flange. The second thickness of the flange on the replacement cylinder liner corresponding to the sum of the first thickness and the depth of the cleaned recess.

In another aspect, the disclosure describes an engine block that has been remanufactured to replace a used cylinder liner and an insert. The engine block includes a top deck and a cylinder bore in the engine block that opens through the top deck. A recess in the top deck surrounds the cylinder bore. The recess has a depth sized to accommodate the insert that has been removed. A replacement cylinder liner is positioned in the cylinder bore. The replacement cylinder liner has a flange on an upper edge thereof that is received in the recess. The flange of the replacement cylinder liner has a thickness that corresponds to a sum of the depth of the recess and a thickness of a flange on the used cylinder liner that has been removed from the cylinder bore.

In yet another aspect, the disclosure describes a replacement cylinder liner for a cylinder bore of an engine block that replaces an insert arranged in a recess surrounding the cylinder bore and a used cylinder liner having a flange on an upper edge thereof. The replacement cylinder liner includes a cylindrical wall and an annular flange arranged at an upper edge of the cylindrical wall. The annular flange has a thickness corresponding to the sum of a depth of the recess and a thickness of the flange of the used cylinder liner.

### BRIEF DESCRIPTION OF THE DRAWINGS

FIG. 1 is a perspective view of an exemplary engine block according to the present disclosure.

FIG. 2 is a partial plan view of the top deck of the engine block of FIG. 1.

FIG. 3 is a partial cross-sectional view of the engine block of FIG. 1 showing a cylinder liner with liner insert prior to removal during remanufacturing of the engine block.

FIG. 4 is a perspective view of an exemplary replacement liner according to the present disclosure for use in remanufacture of the engine block of FIG. 1.

FIG. 5 is a partial cross-sectional view of the engine block of FIG. 1 with the replacement liner of FIG. 4 installed.

FIG. 6 is an enlarged partial cross-sectional view of the engine block of FIG. 1 showing the replacement liner installed with a spacer plate and the cylinder head.

FIG. 7 is an enlarged partial cross-sectional view of the engine block of FIG. 1 showing an alternative embodiment of the flange of the replacement liner.

FIG. 8 is a flow diagram illustrating a method of remanufacturing the engine block of FIG. 1.

### DETAILED DESCRIPTION

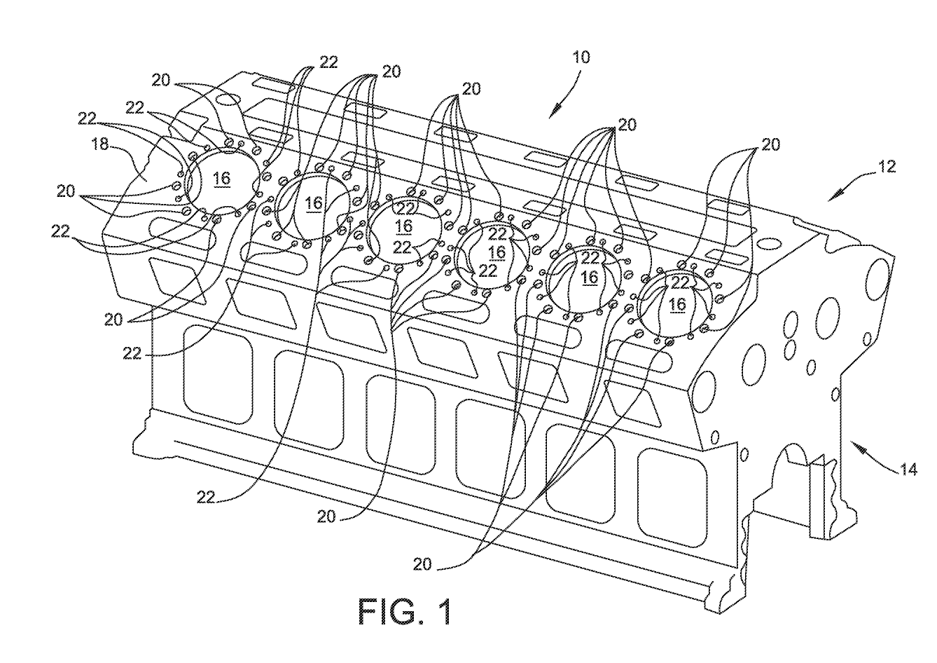

This disclosure generally relates to remanufacturing of engine blocks. With particular reference to FIG. 1, an exemplary embodiment of an engine block 10, also referred to as a cylinder block, is shown. The engine block 10 may, for example, be constructed of cast iron or, alternatively, aluminum or magnesium, or any other desirable material, and may include one or more cylindrically bored holes for receiving pistons of an internal combustion engine, such as a compression ignition engine or a spark-ignited engine. Such an internal combustion engine may be used to power an on-highway or off-highway machine, stationary equipment, or any other known machine or vehicle.

The engine block 10 may be a one-piece casting and may generally include an upper section 12 and a lower section 14 The upper section 12 of the engine block 10 may include a variety of openings, such as cylinder bores, fluid passages, and attachment bores. In the illustrated embodiment, the upper section 12 includes a plurality of cylinder bores 16 formed within the engine block 10 and opening through a top deck 18 of the engine block 10. Although six cylinder bores 16 are shown, it should be appreciated that the engine block 10 may include any number of cylinder bores 16.

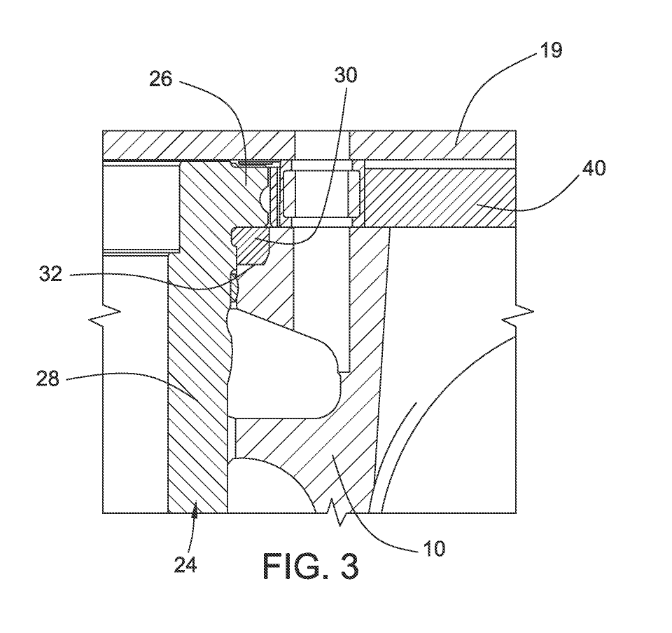

A cylinder head 19 (shown, for example, in FIG. 3) may be attached to the engine block 10, such as, for example, by using a plurality of attachment bolts received within a corresponding number of attachment bores 20. The cylinder head 19, as is known in the art, may seal each of the cylinder bores 16, thus creating combustion chambers therein, and may provide a structure for supporting intake and exhaust valves and/or ports, fuel injectors, necessary linkages, and/or other known devices or structures.

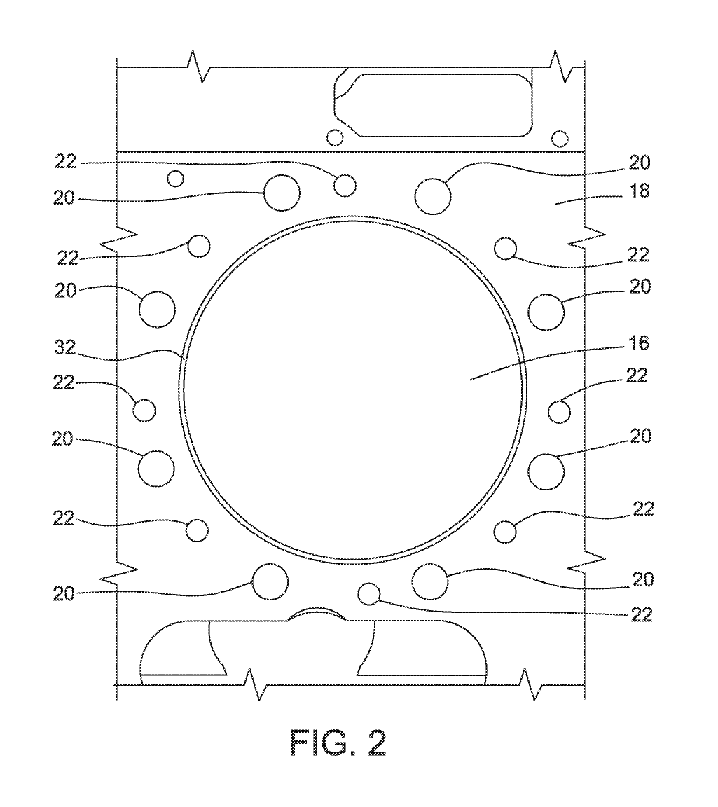

As shown in FIGS. 1 and 2, the upper section 12 of the engine block 10 may also include a plurality of fluid passages 22, such as water passages, circumferentially spaced about each cylinder bore 16. Although eight fluid passages 22 are shown, any number of fluid passages 22 may be provided throughout the engine block 10. Each fluid passage 22 may be formed within the engine block 10 and may open through the top deck 18, as shown. As is known, the fluid passages 22, and additional fluid passages and/or chambers within the engine block 10, may form a water jacket or other similar cooling system for controlling circulation of a coolant and providing proper cooling of the engine block 10.

Each cylinder bore 16 may include a cylinder liner 24 (see FIG. 3). The cylinder liner 10 may include an annular upper flange 26 and a generally cylindrical wall 28. The wall 28 may extend axially downward from an inner portion of the flange 26 at a juncture between the flange 26 and a cylindrical outer surface of the wall 28. An interior surface of the liner 24 may define a bore, which extends through the flange 26 and the cylindrical wall 28 to form a suitable sliding surface for engine pistons within an engine block 10. The cylinder liners 24 may be made of various metals, such as cast iron, and heated or heat-treated or coated using various means. Additionally, the cylinder liners 24 may be machined from one solid material casting.

The lower section 14 of the engine block 10 (see FIG. 1) may also include and/or define a portion of the water jacket described above. The lower section 14 may be of conventional form, and may include a crankcase, in which a crankshaft rotates. While an engine block 10 having a specific configuration is shown and described, it will be appreciated that the present disclosure is applicable to any type and/or configuration of internal combustion engine.

In FIG. 2, a portion of the top deck 18 of the engine block 10 is shown. Particularly, one of cylinder bores 16 and adjacent, or surrounding, attachment bores 20 and fluid passages 22 are shown. During operation of an internal combustion engine, wear or erosion may occur at or adjacent the edges of the cylinder bore 16 along the top deck 18. Additionally, one or more defects or cracks may form within the top deck 18 of the engine block 10 during operation of the engine, or even during the original manufacture thereof. These worn areas, defects and/or cracks in the engine block may be repaired in what may be referred to as a remanufacturing process During a remanufacturing process, material including the worn material, defects and/or cracks from the top deck 18 of the engine block 10 that surrounds the cylinder bore 16 and other openings, such as fluid passages 22, and attachment bores 20, in the top deck 18 may be removed creating recesses in the top deck 18. As used herein, “remanufacturing” may refer broadly to the remanufacture, repair, or other similar process associated with the engine block 10.

Material may be removed from the top deck 18 of the engine block 10 using any known machining process, such as, for example, milling or grinding. The process can be manual and/or automatic. According to one embodiment, for example, a machining tool used to remove material from the engine block 10 may be operated via computer numerical control (CNC). However, any useful tool for removing engine block material according to precise specifications is contemplated.

In a known manner, in certain circumstances, the worn material may be replaced by one or more inserts. Turning now to FIG. 3, an insert 30 is shown positioned within a recess 32 that surrounds one of the cylinder bores 16 of the engine block 10. The insert 30 may generally include a ring-shaped body having a central opening matching, or aligned with, the cylinder bore 16. The insert 30 may be retained within the recess 32 using any known retention method, including, according to one embodiment, an interference fit. Specifically, the insert 30 may be machined, such as using a CNC process, to include dimensions slightly larger than dimensions of the recess 32, such that the insert 30 may be press fit within the corresponding portion of the top deck 18. The insert 30 may be made from stainless steel, or any other useful material, and may have a substantially uniform thickness.

It should be appreciated that wear, erosion, defects, and/or cracks may occur around one or more of the cylinder bores 16 after the insert or inserts 30 are installed. Such areas may be repaired using a further remanufacturing process. In such a process, the insert 30 surrounding each cylinder bore 16 to be repaired may be removed, such as by creating one or more threaded bores within the insert 30 to attach a removal tool. Additionally, the cylinder liner 24 associated with the cylinder bore 16 may be removed from the engine block 10. For example, a shaft screw (not shown) may be used to pull down on a cam lever type tool to loosen the cylinder liner 24. If the cylinder liner 24 sticks in the block, the lever tool may be turned in a clockwise direction until the liner is loosened. The liner puller may then be removed and the cylinder liner 24 lifted from the engine block 10. The insert 30 and cylinder liner 24 do not have to be removed in any particular order and may be removed in any sequence that is possible given the configuration of the insert 30, cylinder liner 24 and engine block 10.

After the insert 30 is removed, the recess 32 in which the insert was sitting may be cleaned. For example, the cleaning may include removal of any unwanted material such as remnants of the insert 30 and/or any adhesive or sealant associated with the insert 30. The cleaning may also involve the removal of additional worn, eroded, cracked or otherwise defective material around the cylinder bore 16. The cleaning may be performed manually or automatically using any suitable machining process. For example, a machining tool used to remove material from the engine block 10 may be operated via computer numerical control (CNC) to clean out the recess 32.

In the course of the cleaning of the recess 32, the recess may be deepened. For example, the recess 32 may be cleaned or machined such that the cleaned recess 32 is deepened to a predetermined depth. While only shown in partial view in FIG. 3, it should be understood that the recess 32 may extend around the entire circumference of the cylinder bore 16. Moreover, it will be understood that the recess 32 for each of the cylinder bores 16 for which the respective insert 30 has been removed may be cleaned as necessary. According to one embodiment, the inserts 30 surrounding each of the cylinder bores 16 may be removed along with the associated cylinder liner 24. The depth of the cleaned out recesses 32 may vary for different engine sizes and types and the nature of the repair being performed and may vary on a single engine block if desired.

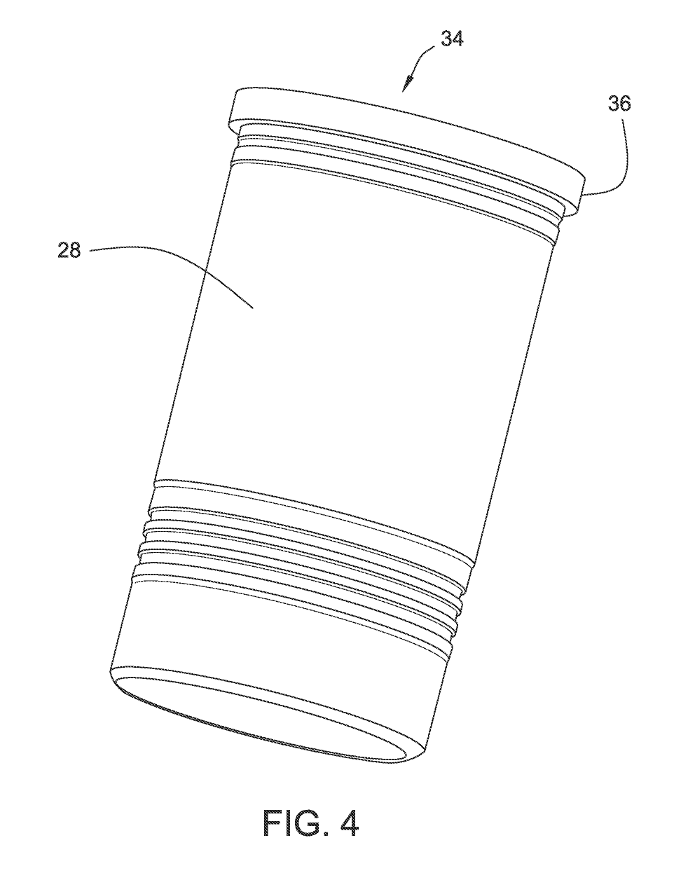

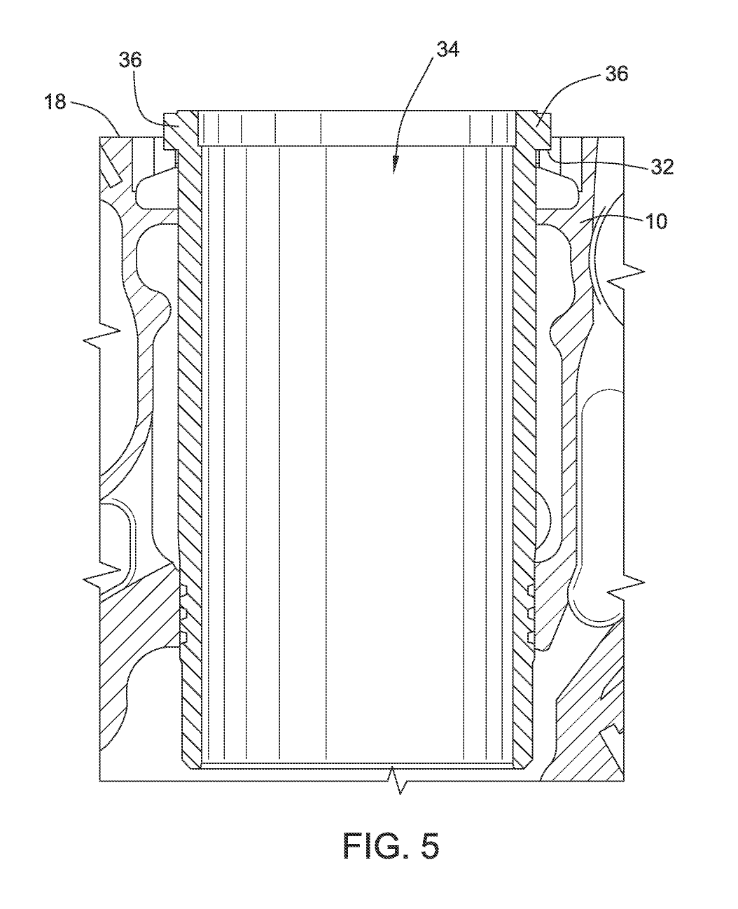

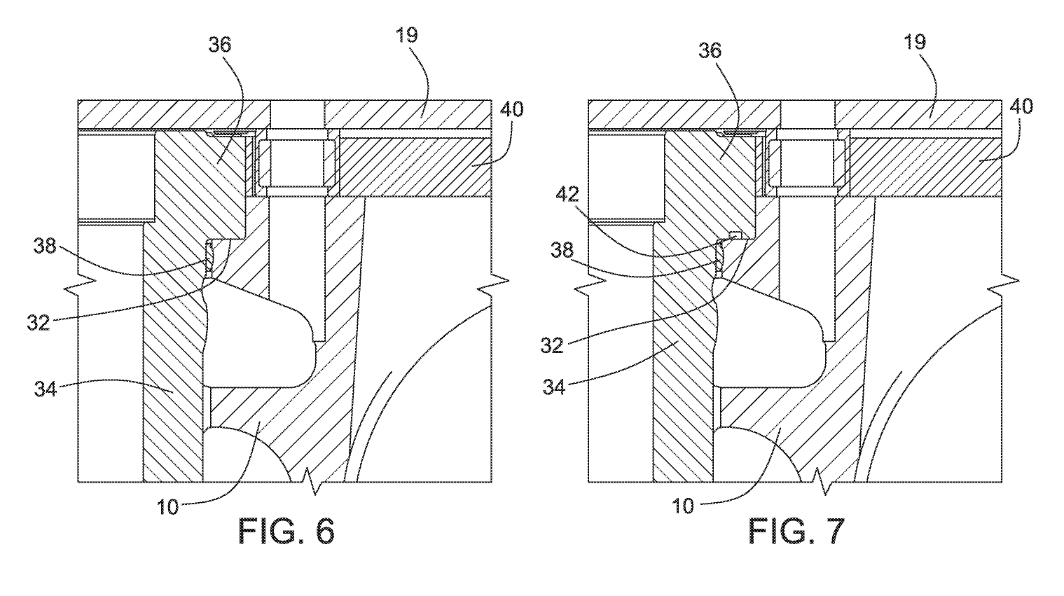

After the recess 32 is cleaned, a new or replacement cylinder liner 34 (shown in FIGS. 4 and 5) may be positioned in the associated cylinder bore 16. The replacement cylinder liner 34 may be configured in such a way that the need for an installation of a new insert 30 in the area around the cylinder bore 16 is eliminated. More specifically, the new replacement liner 34 may be configured with a flange 36 that takes up the space previously occupied by the insert 30 (see, e.g., FIG. 6). As compared to the flange 26 on the used cylinder liner 24 being replaced, the replacement liner 34 may have a flange 36 that is relatively thicker and is sized to compensate for the removal of the insert 30 from the engine block 10. To this end, the flange 36 on the replacement liner 34 may have a thickness corresponding to the sum of the thickness of the flange 26 of the used cylinder liner 24 that is being removed plus the depth of recess 32 in which the insert 30 previously sat after it is cleaned. During the remanufacturing process, the replacement cylinder liner 34 may be press fit into the corresponding cylinder bore 16 after the recess 32 is cleaned such that a lower surface of the flange 36 of the replacement cylinder liner 34 engages the bottom surface of the cleaned recess 34 on the engine block 10. In this way, the engagement of the flange 36 in the recess 32 fixes the replacement liner 34 relative to the cylinder bore 16 and the engine block 10. When installed, the space in the recess 32 previously occupied by the insert 30 is taken up by the flange 36 of the replacement cylinder liner 34 as shown in FIG. 6.

To help prevent fluid flow through the space between the replacement cylinder liner 34 and the cylinder bore 16, an annular liner seal 38 may be provided on the outer surface of the cylindrical wall of cylinder liner 34. The liner seal 38 may be configured to extend into engagement with the wall of the cylinder bore 16 as shown in FIG. 6. After the replacement cylinder liner 34 is in place, a spacer 40 and the cylinder head 19 may be installed attached to the top deck as shown in FIGS. 6 and 7. The spacer 40 and/or the cylinder head 19 may be a new component, a remanufactured component or an original component.

As will be appreciated the depth of the recess 32 and the thickness of the flange 36 of the replacement cylinder liner 34 may controlled in such a way that the top surface of the flange 36 protrudes the same distance above the top deck 18 of the engine block 10 as did the top surface of the flange 26 of the used cylinder liner 24. According to one embodiment, the replacement cylinder liners 34 may have flanges 36 with a select number of common thicknesses and the depth of the recess 32 may be controlled to a variable predetermined depth selected so as to ensure that the flange 36 of the replacement cylinder liner 34 protrudes from the top deck 18 of the engine block 10 the same distance as the flange 26 of the used replacement flange 24. Alternatively, replacement cylinder liners 34 having varying flange thicknesses may be used so that both the selection of replacement liner flange thickness and the depth of the recess 32 may be varied to control the distance by which the flange 36 protrudes above the top deck 18 of the engine block 10.

To enhance sealing between the replacement cylinder liner 34 and the cylinder bore 16, an alternative embodiment of the replacement liner 34 may include a groove 42 in the flange 36 that may receive an o-ring seal. As shown in FIG. 7, the groove 42 may be provided in the lower surface of the flange 36 that contacts the bottom of the recess 32 when the replacement cylinder liner 34 is installed in the cylinder bore 16. A seal provided in the groove 42 can help block the flow of fluids in the space between the flange 36 and recess 32 in which it sits. Additional or alternative sealing measures could also be provided.

### INDUSTRIAL APPLICABILITY

The present disclosure finds potential applicability to any engine block that may be subject to operational loads causing wear, erosion, cracks and/or defects in the areas surrounding the cylinder bores. Although the disclosure describes the remanufacture, or repair, of an engine block that has already been subject to a remanufacturing process in which an insert was installed, the method described herein may also be used during an initial remanufacture instead of installing an insert.

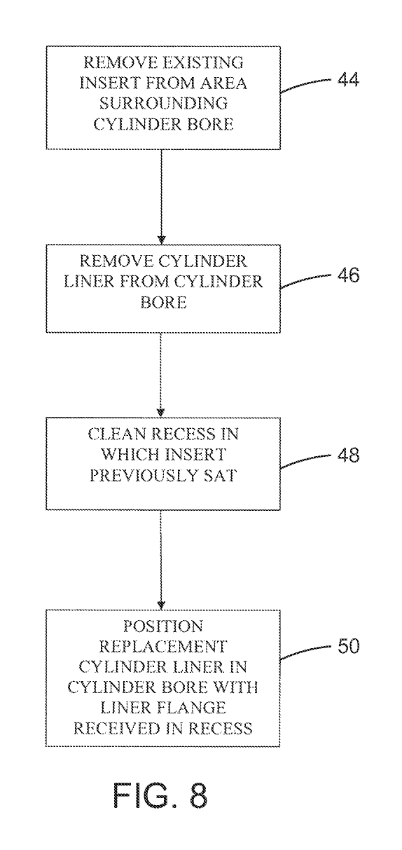

Turning now to FIG. 8, a flow chart showing steps of an exemplary method of remanufacturing an engine block 10 according to the present disclosure is shown. In the method of FIG. 8, the first step 44 involves removing an existing insert 30 from the area surrounding one of the cylinder bores 16 of the engine block 10. In step 46, the used cylinder liner 26 is removed from the cylinder bore 16. In step 48, the recess 32 in the top deck 18 of the engine block 10 in which the insert 30 sat is cleaned. The step of cleaning the recess 32 may involve removing additional material from the engine block 10 such as material that is worn, eroded or cracked. The worn, eroded or cracked material may be discovered in the course of an inspection such as such as a visual inspection, a magneflux check or other known methods. The step of cleaning the recess 32 may also involve removing additional material from the engine block 10 to configure the recess 32 to a predetermined depth. It will be understood that while the steps of removing the insert 30, removing the used cylinder liner 24 and cleaning the recess 32 are shown in a particular order in FIG. 8, the steps may be performed in any sequence that is desired or expedient for the remanufacturing operation. In step 50, the replacement cylinder liner 34 is installed in the cylinder bore 16. As described above, the replacement cylinder liner 16 may have a flange 36 having a thickness corresponding to the thickness of the flange 26 of the original cylinder liner 24 plus the depth of the recess 32.

The elimination of the insert 30 from the engine block 10 can have several benefits. For example, installing the liner seal 38 over an existing insert 30 can be a difficult process. Thus, eliminating the insert 30 can make it easier to install the liner seal 38. Additionally, the elimination of the insert 30 eliminates a possible leakage path in the engine block 10. Eliminating the insert and installing the replacement liner 34 in the recess 32 previously occupied by the insert 20 also may allow the replacement cylinder liner 34 to be located more accurately relative to the engine block 10.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

We claim:

1. A method of remanufacturing an engine block comprising the steps of:
removing an insert from a recess in a top deck of the engine block that surrounds a cylinder bore in the engine block;
removing a used cylinder liner from the cylinder bore, the used cylinder liner having a flange on an upper edge thereof having a first thickness measured between an upper surface of the flange and a lower surface of the flange;
cleaning the recess in the top deck of the engine block, the cleaned recess having a depth measured from the top deck of the engine block to a bottom surface of the recess; and
positioning a replacement cylinder liner in the cylinder bore, the replacement cylinder liner having a flange on an upper edge thereof that is received in the cleaned recess, the flange of the replacement cylinder liner having a second thickness measured between an upper surface of the flange and a lower surface of the flange, the second thickness of the flange on the replacement cylinder liner corresponding to the sum of the first thickness and the depth of the cleaned recess.

2. The method of claim 1 wherein the flange of the replacement cylinder liner includes a groove for receiving a seal.

3. The method of claim 2 wherein the groove is in a lower surface of the flange of the replacement cylinder liner that engages with the bottom surface of the recess when the replacement cylinder liner is positioned in the cylinder bore.

4. The method of claim 1 wherein the step of cleaning the recess includes removing material from the recess.

5. The method of claim 4 wherein the step of cleaning the recess includes increasing the depth of the recess.

6. The method of claim 5 wherein the depth of the recess is increased such that the depth is a predetermined amount.

7. The method of claim 1 wherein a liner seal is arranged between an outer surface of the replacement cylinder liner and an inner wall of the cylinder bore.

8. The method of claim 1 wherein when positioned in the cylinder bore the flange of the replacement cylinder liner protrudes from the top deck of the engine block.

9. An engine block that has been remanufactured to replace a used cylinder liner and an insert, comprising:
a top deck;
a cylinder bore in the engine block and opening through the top deck;
a recess in the top deck surrounding the cylinder bore, the recess having a depth sized to accommodate the insert that has been removed;
a replacement cylinder liner positioned in the cylinder bore, the replacement cylinder liner having a flange on an upper edge thereof that is received in the recess, the flange of the replacement cylinder liner having a thickness that corresponds to a sum of the depth of the recess and a thickness of a flange on the used cylinder liner that has been removed from the cylinder bore.

10. The engine block of claim 9 wherein the flange of the replacement cylinder liner includes a groove for receiving a seal.

11. The engine block of claim 9 wherein the groove is in a lower surface of the flange of the replacement cylinder liner that engages with a bottom surface of the recess when the replacement cylinder liner is positioned in the cylinder bore.

12. The engine block of claim 9 wherein the recess is cleaned after removal of the insert and prior to positioning of the replacement cylinder liner in the cylinder bore.

13. The engine block of claim 9 wherein the depth of the recess is machined to a predetermined amount.

14. The engine block of claim 9 wherein a liner seal is arranged between an outer surface of the replacement cylinder liner and an inner wall of the cylinder bore.

15. The engine block of claim 9 wherein the flange of the replacement cylinder liner protrudes from the top deck of the engine block.

16. The engine block of claim 9 further including a cylinder cap attached to the top deck of the engine block.

17. A replacement cylinder liner for a cylinder bore of an engine block that replaces an insert arranged in a recess surrounding the cylinder bore and a used cylinder liner having a flange on an upper edge thereof, comprising:
a cylindrical wall; and
an annular flange arranged at an upper edge of the cylindrical wall, the annular flange having a thickness corresponding to the sum of a depth of the recess and a thickness of the flange of the used cylinder liner.

18. The replacement cylinder liner of claim 17 wherein the flange of the replacement cylinder liner includes a groove for receiving a seal.

19. The replacement cylinder liner of claim 18 wherein the groove is in a lower surface of the flange.

20. The replacement cylinder liner of claim 17 further including a liner seal arranged on an outer surface of the cylindrical wall.
